(19) United States
(12) Patent Application Publication
(10) Pub. No.: US 2019/0091809 A1
(43) Pub. Date: Mar. 28, 2019

(54) Flux

(71) Applicant: Senju Metal Industry Co., Ltd., Tokyo (JP)

(72) Inventors: Hiroyoshi Kawasaki, Tokyo (JP); Yasuhiro Kajikawa, Tochigi (JP); Yoshinori Hiraoka, Tochigi (JP); Takashi Hagiwara, Tochigi (JP)

(21) Appl. No.: 16/089,489

(22) PCT Filed: Mar. 30, 2017
(86) PCT No.: PCT/JP2017/013226

§ 371 Date: Sep. 28, 2018

(30) Foreign Application Priority Data
Mar. 30, 2016 (JP) 2016-069033

(51) Int. Cl. B23K 35/362; B23K 35/36

(52) U.S. Cl. CPC B23K 35/362; B23K 35/3613

(57) ABSTRACT

Provided is a flux that can delay cured time of a resin within room temperature range and suppress the glass transition point of the resin from being reduced. The flux contains at least one species of α-amino acid and β-amino acid and a thermosetting resin wherein 1 part by weight or more and 30 parts by weight or less of α-amino acid or β-amino acid, or α-amino acid and β-amino acid are added for 100 parts by weight of the thermosetting agent.

### TECHNICAL FIELD

The present invention relates to a flux to which a curable resin is added.

### BACKGROUND TECHNOLOGY

The flux used for soldering generally has such an efficiency that it can chemically remove any metal oxides existed on a solder alloy and metal surfaces of an object to be joined, which is an object to be soldered, and a joined object and metal elements can be transferred through a boundary of them. Therefore, by performing the soldering using the flux, it is possible to produce an intermetallic compound between the solder alloy and the metal surfaces of the object to be joined and the joined object, thereby obtaining strong joining.

As recent miniaturization of electronic components has been progressed, an electrode which is a point to be joined by the solder alloy has been reduced. Therefore, an area that can be joined by the solder alloy has been miniaturized, so that there may be a case where joining strength by only the solder alloy is insufficient for joining reliability.

Accordingly, a technology such that an electronic component or the like is fixed by covering a circumference of the join by the solder alloy with a resin such as underfill as component-fixing means for enhancing the soldered join has been proposed (For example, see Patent Document 1).

On the other hand, the flux component contains a component that is not decomposed and/or evaporated at a heating temperature during the soldering time, which remains around the join as flux residue after the soldering.

Here, when the flux residue remains around the join by the solder alloy, the flux residue inhibits the join and the resin from being joined to each other so that it may be impossible to maintain the strength. Therefore, in order to cover a circumference of the join with the resin, it is necessary to clean the flux residue. It, however, takes any time and costs to clean the flux residue. Further, along with narrowing a gap by the miniaturization of electronic component or the like, it has been difficult to clean the flux residue itself.

Accordingly, a technology such that an object to be joined and a joined object are joined to each other by the resin contained in the flux residue by adding a thermosetting resin to the flux has been proposed (For example, see Patent Document 2).

### DOCUMENTS FOR PRIOR ART

### Patent Documents

Patent Document 1: Japanese Patent Application Publication No. 2001-007158

Patent Document 2: Japanese Patent Application Publication No. 2001-219294

### SUMMARY OF THE INVENTION

### Problems to be Solved by the Invention

However, in the flux to which the thermosetting resin and the hardening agent are added, a reaction between the resin and the hardening agent proceeds even within an ordinary temperature range, so that viscosity of the flux increases with the lapse of time.

In addition, a function of the flux to remove a metal oxide film can be enhanced by adding an organic acid and/or amine as an activator to the flux. In this case, however, a reaction between the organic acid and/or amine and the resin proceeds, viscosity of the flux also increases during the storage time thereof. Further, because the reaction between the resin and the activator proceeds, solderability thereof deteriorates. The activator added to the flux also falls down a glass transition point of the resin.

This invention solves the above-mentioned problems and has an object to provide a flux which can delay curing of the resin and suppress a drop of the glass transition point of the resin.

### Means for Solving the Problems

It has been found out that in the flux to which a curable resin is added, the curing of the resin by the reaction between the resin and the hardening agent and the reaction between the resin and an amino acid can delay and the drop of the glass transition point of the resin can be also suppressed by adding the amino acid containing a carboxyl group and an amino group and a predetermined carbon number or less between the carboxyl group and the amino group.

Therefore, this invention relates to a flux containing at least one species of α-amino acid and β-amino acid and a thermosetting resin wherein 1 part by weight or more and 30 parts by weight or less of the α-amino acid or the β-amino acid, or the α-amino acid and the β-amino acid is added for 100 parts by weight of the thermosetting agent.

As α-amino acid, glycine, alanine, asparagine, aspartic acid, glutamine, glutamic acid and serine are exemplified and as β-amino acid, β-alanine is exemplified.

### Effects of the Invention

In the flux according to this invention, by adding at least one species of the α-amino acid and β-amino acid in a predetermined proportion of a curable resin including the thermosetting resin and the hardening agent, the reaction between the resin and the hardening agent and the reaction between the resin and the amine are suppressed, thereby delaying the curing of the resin. This enables any increase in the viscosity during the storage time to be suppressed.

In addition, in the flux according to this invention, both of the α-amino acid and the β-amino acid function as activators for removing the metal oxides.

Further, in the flux according to this invention, even by adding at least one species of the α-amino acid and the β-amino acid, the drop of the glass transition point of the resin is suppressed without inhibiting the resin from curing by heat.

### EMBODIMENT FOR CARRYING OUT THE INVENTION

The following will describe a flux according to embodiments of this invention. To the flux according to this embodiment, an amino acid(s) is (are) added as the activator and the thermosetting resin and the hardening agent are added as the curable resin. In addition, to the flux according to this embodiment, any solvents are added.

The amino acid having a carboxyl group and an amino group forms a dipolar ion and the carboxyl group allows reactivity between an amino group in the amino acid and the resin to be suppressed without inhibiting the reactivity between the amino acid and the metal oxides. When, however, the carbon number between the carboxyl group and the amino group is 3 or more, the cured resin has flexibility. For example, γ-amino acid in which the carbon number between the carboxyl group and the amino group is 3 or δ-amino acid in which the carbon number between the carboxyl group and the amino group is 4, flexibility occurs in molecular structure of polymerized resin, thereby falling down the glass transition point thereof. Accordingly, at least one species of the α-amino acid and β-amino acid, the carbon number between the carboxyl group and the amino group of which is 2 or less, is added.

The α-amino acid preferably is glycine or aspartic acid. In addition, the β-amino acid preferably is β-alanine.

The thermosetting resin is selected from an epoxy resin, a phenol resin (novolak resin) and the like, which are generally-known. In a case of the epoxy resin, bisphenol A type is preferable. The hardening agent is selected from acid anhydride, imidazole, a compound having an imidazole ring, dicyandiamide, hydrazide and the like, which are generally-known. In a case of the imidazole, 1,2-dimethylimidazole, 2-ethyl-4-methylimidazole, 2-phenylimidazole, 4-methyl-2-phenylimidazole, 1-benzyl-2-methylimidazole, 1-benzyl-2-phenylimidazole, 2-phenyl-4,5-dihydroxymethylimidazole, 2-phenyl-4-methyl-5-hydroxymethylimidazole and the like are exemplified. As the compound having the imidazole ring, 2,4-diamino-6-(2′-methylimidazolyl-(1′))-ethyl-s-triazine, 2,4-diamino-6-(2′-undecylimidazolyl-(1′)) -ethyl-s-triazine, 2,4-diamino-6-(2′-ethy-4′-methylimidazolyl-(1′))-ethyl-s-triazine and the like are exemplified.

It is preferable that an additive amount of the hardening agent for the thermosetting resin is 1% by mass or more and 7% by mass or less in a case of the imidazole, the compound having the imidazole ring and the dicyandiamide, but is 30% by mass or more and 60% by mass or less in a case of the acid anhydride and the hydrazide.

In addition, a solvent, filler such as silica, silane coupling agent, dispersing agent, other resin such as rubber or thermoplastic resin, solder powder or the like may be added to the flux. The solvent is selected from generally-known glycol ether based compounds.

### EXECUTED EXAMPLES

Fluxes of the Executed Examples and the Comparison Examples having compositions shown in following Tables were prepared to verify viscosity increase rate of the flux and the glass transition point (Tg). Numerical values of the amino acid, the amine and the organic acid in each of the Tables represent parts by weight of the amino acid, the amine and the organic acid if the resin is set to be 100 parts by weight. In addition, as the hardening agent, 3% by mass of 2-etyle-4-methylimidazole was added to the resin. This invention is not limited to the following concreate examples.

(1) Regarding the Verification of Viscosity Increase Rate of Flux

(a) Evaluation Method

The fluxes of the Executed Examples and the Comparison Examples were stored at a room temperature (25 degrees C.) and their acceleration tests were performed. Viscosities at an initial time, after 5 hours elapsed and after 18 hours elapsed were measured and the viscosity increase rates were calculated when the viscosity of the initial time was set to be 100%.

(b) Determination Criterion

O: When the viscosity increase rate of the reference example consisting of the resin and the hardening agent was set to be a threshold value, the viscosity increase rate after 5 hours elapsed was138% or less and the viscosity increase rate after 18 hours elapsed was 378% or less.

X: When the viscosity increase rate of the reference example consisting of the resin and the hardening agent was set to be a threshold value, the viscosity increase rate after 5 hours elapsed was more than 138% and the viscosity increase rate after 18 hours elapsed was more than 378%.

(2) Regarding the Verification of the Glass Transition Point in the Flux

(a) Evaluation Method

According to Differential Scanning calorimetry (DSC), the glass transition points of the fluxes of the Executed Examples and the Comparison Examples were measured under N₂ atmosphere with the temperature increasing from 25 degrees C. to 300 degrees C. at a temperature-increasing speed of 20 degrees C./min

(b) Determination Criterion

O: When the glass transition point of the reference example consisting of the resin and the hardening agent was set to be a threshold value, the glass transition point was 140.3 degrees C. or more.

X: When the glass transition point of the reference example consisting of the resin and the hardening agent was set to be a threshold value, the glass transition point was less than 140.3 degrees C.

TABLE 1

| | | Executed | Executed | Executed | Executed | Executed | Executed | Executed | Executed | Executed |
|---|---|---|---|---|---|---|---|---|---|---|
| | | Example | Example | Example | Example | Example | Example | Example | Example | Example |
| | | 1 | 2 | 3 | 4 | 5 | 6 | 7 | 8 | 9 |
| α-Amino | Glycine | 1 | 10 | 20 | 30 | | | | | |
| Acid | | | | | | | | | | |
| α-Amino | L-Aspartic | | | | | 10 | | | | |
| Acid | Acid | | | | | | | | | |
| β-Amino | β-Alanine | | | | | | 1 | 10 | 20 | 30 |
| Acid | | | | | | | | | | |
| Epoxy | Bisphenol | 100 | 100 | 100 | 100 | 100 | 100 | 100 | 100 | 100 |
| Resin | A Type | | | | | | | | | |
| Viscosity | 5 hrs | ∘ | ∘ | ∘ | ∘ | ∘ | ∘ | ∘ | ∘ | ∘ |
| Increase | 18 hrs | ∘ | ∘ | ∘ | ∘ | ∘ | ∘ | ∘ | ∘ | ∘ |
| Rate | | | | | | | | | | |

| | | | | | | | | | |
|---|---|---|---|---|---|---|---|---|---|
| Glass Transition Point | ∘ | ∘ | ∘ | ∘ | ∘ | ∘ | ∘ | ∘ | ∘ |
| (Tg) ° C. | | | | | | | | | |

TABLE 2

| | | Comparison | Comparison | Comparison | Comparison | Comparison | Comparison | Comparison | Reference |
|---|---|---|---|---|---|---|---|---|---|
| | | Example 1 | Example 2 | Example 3 | Example 4 | Example 5 | Example 6 | Example 7 | Example |
| α-Amino | Glycine | 50 | | | | | | | |
| Acid | | | | | | | | | |
| β-Amino | β-Alanine | | 50 | | | | | | |
| Acid | | | | | | | | | |
| γ-Amino | 4-Aminobutanoic | | | 10 | | | | | |
| Acid | Acid | | | | | | | | |
| ϵ-Amino | 6-Aminobutanoic | | | | 10 | | | | |
| Acid | Acid | | | | | | | | |
| ϵ-Amino | ϵ-Caprolactam | | | | | 10 | | | |
| Acid | | | | | | | | | |
| Derivative | | | | | | | | | |
| Amine | Ethylene | | | | | | 10 | | |
| | Diamine | | | | | | | | |
| Carboxylic | Malonic Acid | | | | | | | 10 | |
| Acid | | | | | | | | | |
| Epoxy | Bisphenol | 100 | 100 | 100 | 100 | 100 | 100 | 100 | 100 |
| Resin | A Type | | | | | | | | |
| Viscosity | 5 hrs | ∘ | ∘ | x | x | x | x | x | 138% |
| Increase | 18 hrs | x | x | x | x | x | x | x | 373% |
| Rate | | | | | | | | | |

| | | | | | | | | |
|---|---|---|---|---|---|---|---|---|
| Glass Transition Point | x | ∘ | x | x | x | x | x | 140.3 |
| (Tg) ° C. | | | | | | | | |

As shown in Table 1, in the Executed Examples 1 through 4 in which 1 part by weight or more and 30 parts by weight or less of glycine was added as the α-amino acid when the resin is set to be 100 parts by weight, their viscosity increase rates indicated values which were equal to or less than the value in a case consisting of the resin and the hardening agent. In addition, the glass transition points indicated values which were equal to or more than the value in a case consisting of the resin and the hardening agent.

In the Executed Example 5 in which 10 parts by weight of L-aspartic acid was added as the α-amino acid, the viscosity increase rates also indicated a value which was equal to the value in a case consisting of the resin and the hardening agent and the glass transition point indicated a value which exceeded the value in a case consisting of the resin and the hardening agent.

Additionally, in the Executed Examples 6 through 9 in which 1 part by weight or more and 30 parts by weight or less of β-alanine was added as the β-amino acid, the viscosity increase rates indicated values which were equal to or less than the value in a case consisting of the resin and the hardening agent and the glass transition points indicated values which were equal to or more than the value in a case consisting of the resin and the hardening agent.

In contrast, as shown in Table 2, in the Comparison Example 1 in which 50 parts by weight of glycine was added as the α-amino acid, the viscosity increase rate after 5 hours elapsed indicated a value which was equal to the value in a case consisting of the resin and the hardening agent but the viscosity increase rate after 18 hours elapsed indicated a value which exceeded the value in a case consisting of the resin and the hardening agent. In addition, the glass transition point indicated a value which was less than the value in a case consisting of the resin and the hardening agent.

In the Comparison Example 2 in which 50 parts by weight of β-alanine was added as the β-amino acid, the viscosity increase rate after 5 hours elapsed indicated a value which was equal to the value in a case consisting of the resin and the hardening agent. In addition, the glass transition point indicated a value which was equal to the value in a case consisting of the resin and the hardening agent. The viscosity increase rate after 18 hours elapsed, however, indicated a value which exceeded the value in a case consisting of the resin and the hardening agent.

In the Comparison Example 3 in which 10 parts by weight of 4-aminobutanoic acid was added as the γ-amino acid, the viscosity increase rate indicated a value which exceeded the value in a case consisting of the resin and the hardening agent and the glass transition point indicated a value which was less than the value in a case consisting of the resin and the hardening agent. In addition, in the Comparison Example 4 in which 10 parts by weight of 6-aminohexanoic acid was added as the ε-amino acid, the viscosity increase rate indicated a value which exceeded the value in a case consisting of the resin and the hardening agent and the glass transition point indicated a value which was less than the value in a case consisting of the resin and the hardening agent. Further, in the Comparison Example 5 in which 10 parts by weight of ε-caprolactam was added as the ε-amino acid derivative, the viscosity increase rate indicated a value which exceeded the value in a case consisting of the resin and the hardening agent and the glass transition point indicated a value which was less than the value in a case consisting of the resin and the hardening agent.

In the Comparison Example 6 in which 10 parts by weight of ethylene diamine was added as the amine instead of the amino acid, the viscosity increase rate indicated a value which exceeded the value in a case consisting of the resin and the hardening agent and the glass transition point indicated a value which was less than the value in a case consisting of the resin and the hardening agent. In addition, in the Comparison Example 7 in which 10 parts by weight of malonic acid was added as the organic acid, the viscosity increase rate indicated a value which exceeded the value in a case consisting of the resin and the hardening agent and the glass transition point indicated a value which was less than the value in a case consisting of the resin and the hardening agent.

From the above, it has been understood that the fluxes of the Executed Examples 1 through 9 in which 1 part by weight or more and 30 parts by weight or less of the α-amino acid or β-amino acid, carbon number between the carboxyl group and the amino group of which is 2 or less, is added for 100 parts by weight of the curable resin, it is possible to delay the curing of the resin at a room temperature as compared with the curable resin consisting of the resin and the hardening agent. This enables the increase in the viscosity during the storage time to be suppressed.

It has been also understood that even when at least one species of the α-amino acid and the β-amino acid is added, it is possible to suppress the drop of the glass transition point of the resin without inhibiting the curing of the resin by heat. Accordingly, for example, by performing the soldering using solder balls, the resin in the flux residue was cured and the object to be joined and the joined object were fixed by the resin in addition to the joint of the joined portion by the solder. In addition, the similar effect was obtained in the flux to which a total amount of 1 part by weight or more and 30 parts by weight or less of the α-amino acid and β-amino acid was added for 100 parts by weight of the curable resin.

However, since the amino acid generates decarboxylation reaction, reinforcement to be a target becomes weak in a high temperature range of 300 degrees C. or more. Therefore, an upper limit of the temperature in the soldering time is less than 300 degrees C., preferably about 260 to 270 degrees C.

In addition, both of the α-amino acid and the β-amino acid function as an activator for removing any metal oxides and they suppress any reaction with the resin. From this, it has been understood that wettability of the solder alloy to the joined portion is maintained without damaging the solderability.

In contrast, it has been understood that the fluxes of the Comparison Examples 1 and 2 in which more than 30 parts by weight of the α-amino acid or β-amino acid for 100 parts by weight of the curable resin, if a period of storage time elongates, the curing of the resin proceeds at a room temperature as compared with the curable resin consisting of the resin and the hardening agent. Therefore, in the Comparison Examples 1 and 2, since the curing of the resin proceeds at a room temperature, it is impossible to suppress any increase in the viscosity during the storage time.

In the flux of the Comparison Example 1 in which more than 30 parts by weight of the α-amino acid is added, it has also been understood that the drop of the glass transition point cannot be suppressed. Therefore, when the soldering is performed using the flux of the Comparison Example 1, the resin in the flux residue became flexible, so that it is impossible to fix the object to be joined and the joined object with the resin.

Further, it has been understood that in the fluxes of the Comparison Examples 3 and 4 in which a predetermined amount of the amino acid, carbon number between the carboxyl group and the amino group of which is 3 or more, among the amino acids is added, the curing of the resin proceeds at a room temperature as compared with the curable resin consisting of the resin and the hardening agent and it has also been understood that it is impossible to suppress the drop of the glass transition point of the resin. In the Comparison Example 5 in which a predetermined amount of ε-caprolactam as the ε-amino acid derivative is added, it has been understood that the curing of the resin proceeds at a room temperature as compared with the curable resin consisting of the resin and the hardening agent and it has also been understood that it is impossible to suppress the drop of the glass transition point of the resin.

In addition, in the flux of the Comparison Example 6 in which a predetermined amount of amine normally using as the activator is added, and in the flux of the Comparison Example 7 in which a predetermined amount of organic acid is added, it has been understood that the curing of the resin proceeds at a room temperature as compared with the curable resin consisting of the resin and the hardening agent and it has also been understood that it is impossible to suppress the drop of the glass transition point of the resin.

Accordingly, in the fluxes of the Comparison Examples 3 through 7, the curing of the resin proceeds at a room temperature, so that it is impossible to suppress the increase in the viscosity during the storage time. When performing the soldering using the fluxes of the Comparison Examples 3 through 7, the resin in the flux residue became flexible, so that it was impossible to fix the object to be joined and the joined object with the resin.

Since curing reaction rate of the resin depends on the temperature, from a result of the acceleration test for storing at a room temperature, it has been understood that it is possible to suppress any increase of the viscosity during a chilled storage time or a freezing storage time.

1. A flux containing:
an α-amino acid and/or a β-amino acid; and
a thermosetting resin
wherein 1 part by weight or more and 30 parts by weight or less of at least one species of the α-amino acid and the β-amino acid is added for 100 parts by weight of the thermosetting agent.

2. The flux according to claim 1, wherein the flux comprises the α-amino acid, wherein the α-amino acid is glycine, alanine, asparagine, aspartic acid, glutamine, glutamic acid and/or serine.

3. The flux according to claim 1, wherein the flux comprises the β-amino acid, wherein the β-amino acid is β-alanine.
